(19) United States
(12) Patent Application Publication
(10) Pub. No.: US 2015/0363048 A1
(43) Pub. Date: Dec. 17, 2015

(54) SYSTEM AND METHOD FOR TOUCH RIBBON INTERACTION

(71) Applicant: Siemens Product Lifecycle Management Software Inc., Plano, TX (US)

(72) Inventors: Michael Brown, Lakewood, CA (US); Siarhei Sadouski, Irvine, CA (US); Daniel Sicking, Lakewood, CA (US); Dick Baardse, Geldermalsen (NL)

(21) Appl. No.: 14/496,836

(22) Filed: Sep. 25, 2014

Related U.S. Application Data
(60) Provisional application No. 62/012,277, filed on Jun. 14, 2014.

(51) Int. Cl. G06F 3/0482; G06F 3/0485; G06F 3/0488; G06F 3/0483

(52) U.S. Cl. CPC G06F 3/0482; G06F 3/0483; G06F 3/0485; G06F 3/04886; G06F 3/04883

(57) ABSTRACT

Methods for user interaction and corresponding systems and computer-readable mediums. A method includes displaying a user interface that includes a menu bar having a plurality of tabs, each associated with at least one sub-menu item, and including an active tab and at least one non-active tab. The method includes displaying an active ribbon that includes the sub-menu items associated with the active tab and receiving an interaction input. The method includes scrolling the active ribbon to display additional sub-menu items based on the interaction input, including simultaneously displaying sub-menu items associated with the active tab and at least one sub-menu item associated with a non-active tab. The method includes designating a next adjacent non-active tab as the active tab, and designating the previous active tab as a non-active tab, when at least half of the additional sub-menu items are sub-menu items associated with the next adjacent non-active tab.

### CROSS-REFERENCE TO OTHER APPLICATION

This application claims the benefit of the filing date of U.S. Provisional Patent Application 62/012,277, filed Jun. 14, 2014, for “System and Method for Touch Screen Ribbon Interaction,” which is hereby incorporated by reference.

### TECHNICAL FIELD

The present disclosure is related to interacting with a touch screen computer program, including, but not limited to, those directed to computer-aided design, visualization, and manufacturing systems (“CAD/CAM systems”), product lifecycle management (“PLM”) systems, and similar systems, that manage data for products and other items (collectively, “Product Data Management” systems or PDM systems).

### BACKGROUND OF THE DISCLOSURE

Interaction with a User Interface (UI) that uses a ribbon style layout can be cumbersome due to the need to tap small tab areas to change the active tab when interacting within reduced-sized computing devices, including, but not limited to, smart phones, mobile phones, mobile devices, tablets, etc. Improved systems are desirable.

### SUMMARY OF THE DISCLOSURE

Various disclosed embodiments include methods and systems for interacting with a ribbon menu system in a touch screen environment. Disclosed embodiments include methods for user interaction and corresponding systems and computer-readable mediums. A method includes displaying a user interface that includes a menu bar having a plurality of tabs. Each tab is associated with at least one sub-menu item, and the plurality of tabs includes an active tab and at least one non-active tab. The method includes displaying, in the menu bar, an active ribbon that includes the sub-menu items associated with the active tab and receiving, in the menu bar, an interaction input. The method includes scrolling the active ribbon to display additional sub-menu items based on the interaction input, including simultaneously displaying sub-menu items associated with the active tab and at least one sub-menu item associated with a non-active tab. The method includes designating a next adjacent non-active tab as the active tab, and designating the previous active tab as a non-active tab, when at least half of the additional sub-menu items are sub-menu items associated with the next adjacent non-active tab.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates an embodiment having an illustrative menu bar;

FIG. 3 illustrates an embodiment of a ribbon layout following initial pan gesture;

FIG. 4 illustrates an embodiment switching active tabs from the previous active tab of menu bar to new active tab during pan gesture;

FIG. 5 illustrates an illustrative embodiment of a ribbon tab layout that includes scrolling;

FIG. 6 illustrates an embodiment wherein interaction is supported in one or more vertically scrolling menus; and

FIG. 7 illustrates a flowchart of a process in accordance with disclosed embodiments.

### DETAILED DESCRIPTION

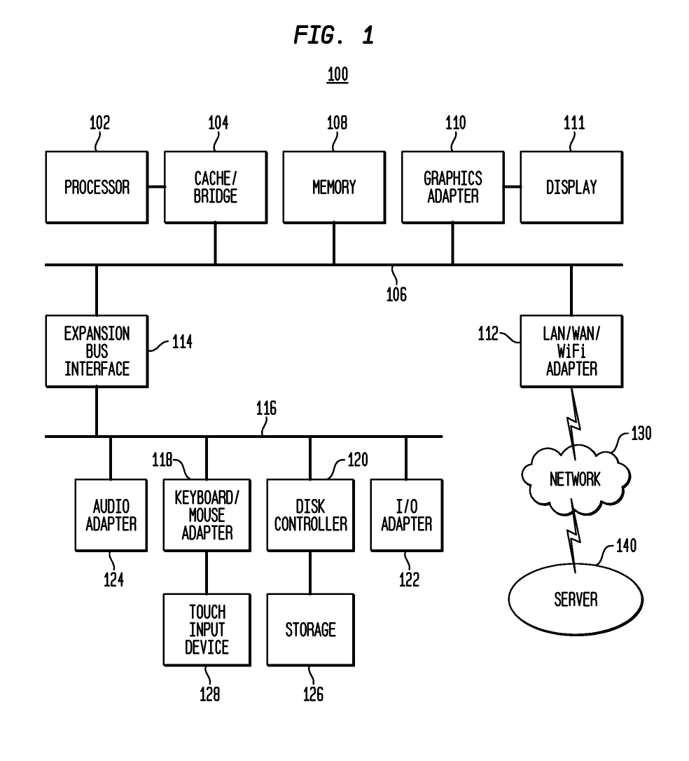

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Interaction with complex computer programs is difficult and cumbersome when operated on a mobile device or tablet device (such as one including a touch screen) for reasons including but not limited to, the limited space on which a user can interact with numerous menu choices. Disclosed embodiments provide a convenient, intuitive user interface operation that allows navigation of ribbon tabs using touch-based input. In order to be intuitive, the interaction can also provide visual feedback that conveys the result of navigating. Ideally, interacting can be simple to perform using touch input and feel as if it is a natural interaction with a physical object. An interaction input may be via a user's finger or other pointing device, such as a stylus, on a touchscreen, touchpad, or similar input.

FIG. 1 illustrates a block diagram of a data processing system in which an embodiment can be implemented, for example as a PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device, such as a mouse, trackball, or otherwise, and specifically can connect to a touch input device 128 such as a trackpointer, touchscreen, touchpad, etc. The touch input device, in some embodiments, can be integrated with the display 111, for example as a touchscreen.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

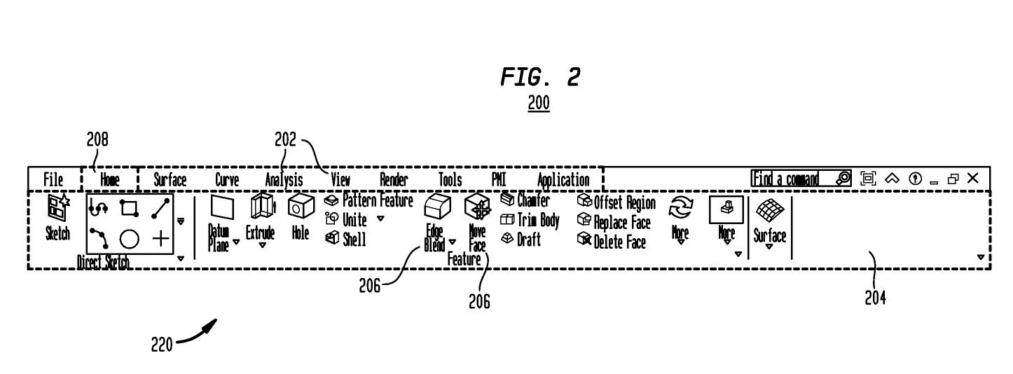

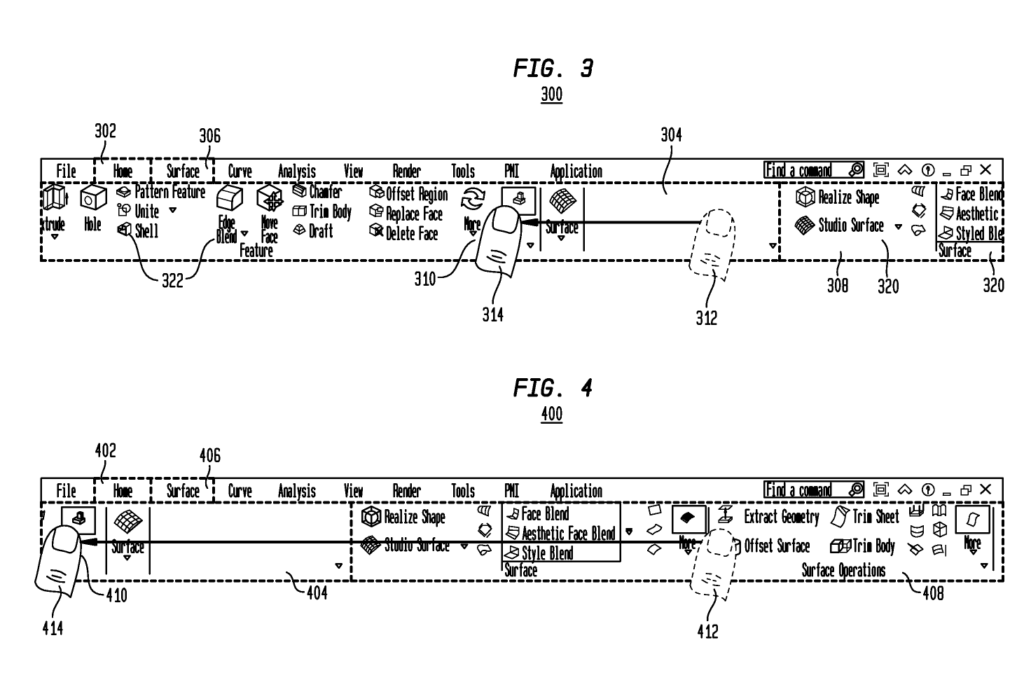

FIG. 2 illustrates an embodiment having an illustrative menu bar 200. Other menu bars are contemplated and are not limited to those illustrated herein, and while the exemplary menu bars illustrated herein show functions and commands related to CAD drafting, the techniques described herein can apply to any menu bar regardless of the specific functions and commands used in the menu bar. In the examples below, a right-to-left interaction input is shown, but the same techniques can be used for left-to-right interaction inputs, with the corresponding directions reversed in response. A user interface 220 is represented by a box, and though not shown in every figure, those of skill in the art will recognize that the described menu bars are part of a data processing system user interface.

Menu bar 200 includes one or more tabs 202, each of which having one or more sub-menu items 206 illustrated as a plurality of icons or selections in the active ribbon 204. While the term “tab” is used herein to describe the selectable menu items, this term is intended to include any type of selectable menu item, for commands or functions, that corresponds to one or more sub-menu items as described herein.

In one embodiment, a user cannot see the entire active ribbon 204 (that is, all of the sub-menu items included in that active ribbon) due to space constrictions so that only sub-menu items 206 associated with the active tab 208 can be viewed at a given time. Further, the sub-menu items 206 associated with the active tab may not fit in the display at a given time. At the same time, one or more sub-menu items associated with other, non-active tabs 202 are not displayed at all.

According to disclosed embodiments, the system can receive a user interaction with said menu bar 200 and to display one or more additional sub-menu items 206 available in the active tab 204 by receiving an interaction input such as the user's finger, stylus, or other means “swiping” from left to right or from right to left, in what is referred to herein as a “pan” gesture. As the interaction input moves to the left, one or more additional sub-menu items 206 appears to the right of the screen; as the interaction input moves to the right, one or more additional sub-menu items 206 appears to the left of the screen.

In some embodiments, this allows the user to “scroll through” the sub-menu items 206 for each of the tabs 202, in order. That is, as illustrated in this example where the “Home” tab is the active tab 208, the system responds to a right-to-left interaction input by displaying any other “Home” sub-menu items from the right side of the menu bar 200. When all of the “Home” sub-menu items have been displayed, the system can change the active tab 208 to the next adjacent non-active tab 202 (the “Surface” tab in this case) and display sub-menu items corresponding to the “Surface” tab instead.

FIG. 3 illustrates an embodiment of a ribbon layout following initial pan gesture. This figure illustrates a menu bar 300 corresponding to the example menu bar 200 of FIG. 2. In this figure, the “home” tab is the active tab 302. The “Surface” tab is the next adjacent non-active tab 306. The active ribbon area 304 indicates an area of the ribbon that corresponds to the active tab 302, with its associated sub-menu items 322. Adjacent ribbon area 308 indicates an area of the ribbon that corresponds to adjacent non-active tab 306, with its associated sub-menu items 320. Interaction input 310, a pan gesture in this example, is not displayed on the ribbon; this represents the interaction input from a user, such as a finger or stylus touch on the ribbon, as it moves from the initial position 312 (the initial touch of the gesture) to the final position 314 (the “lift” of the touch).

In this example, as the interaction input 310 moves left from initial position 312 to final position 314, the active ribbon area 304 is moved to the left (so that the leftmost portion moves out of the menu bar 300) and the adjacent ribbon area moves into the menu bar 300 from the right as it is “dragged” into view.

FIG. 4 illustrates an embodiment switching active tabs from the previous active tab 402 of menu bar 400 to new active tab 406 during pan gesture 410. In this case, the “Home” tab 402 changes from being the active tab to the adjacent tab, and former adjacent “Surface” tab 406 becomes the new active tab. The currently-active tab can be indicated on the menu bar 400, such as by highlighting it in a different color or shade, as tab 406 is in this example. This figure shows that as the pan gesture 410 continues by moving the interaction input from initial position 412 to final position 414, the previous active ribbon area 404 moves off the menu bar 400 to the left, and the previously-adjacent ribbon area 408 moves into the menu bar 400 and becomes the active ribbon area.

As illustrated in FIGS. 3-4, the currently displayed ribbon area tracks the position of the interaction input, and the adjacent ribbon area in the opposite direction of the motion will drag in next to the tab being moved. Visually this appears as one continuous chain of tabs and corresponding ribbon area with sub-menu items. If the active tab is located at the beginning or end of the list of ribbon tabs, then the interface may optionally wrap the other end of the list or stop at the current position.

In an embodiment, if the pan gesture drag takes the active ribbon beyond the midway point of the menu bar, the active tab preferably changes to the adjacent tab being pulled in from behind. This is indicated by a highlight on the tab flags text, a color, font, or other mechanism that indicates it is active.

The behavior of the ribbon at the time the interaction input ends can depend on the velocity of the interaction input at release and the current position of the scroll of the active ribbon area. For example, in the case of no velocity or slight movement, the active ribbon area preferably uses its “inertia” in the movement direction and then animates to the currently active tab starting position. Accordingly, if there is enough movement velocity when the interaction input stops, the active tab may switch as a result of the inertia and return to the next adjacent tab instead of the active tab at the time of the touch release at the final position. If the velocity is beyond a threshold at the release of the interaction input, the active ribbon tab preferably quickly animates to the next tab in the direction of the movement. This is referred to as a “ribbon flick” or just “flick gesture.”

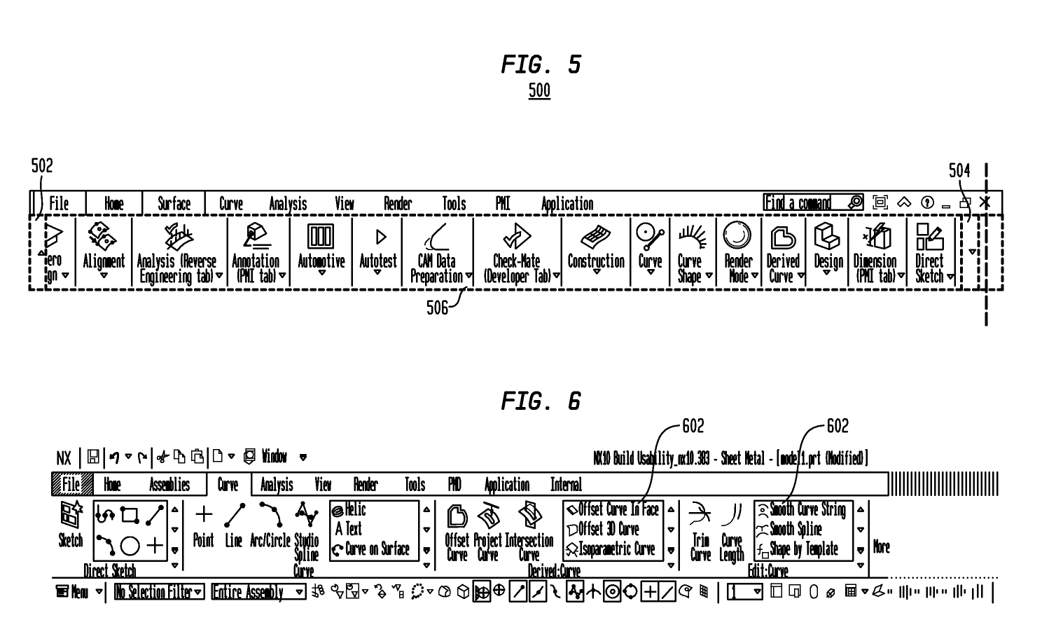

FIG. 5 illustrates an illustrative embodiment of a ribbon tab layout that includes scrolling. In this example, menu bar 500 includes scroll indicator 502 and scroll indicator 504, which can be used to indicate the borders of the active ribbon area 506, and so give a visible indication of when each active ribbon area is scrolling in to and out of the menu bar 500.

In an embodiment, the ribbon layout includes scrolling within a tab if there is not sufficient space for all the sub-menu items. In the event that scrolling is necessary to view all items on a given tab, the scroll preferably transitions smoothly upon reaching the limits of the scrolling area into a pan gesture. In conjunction with this, as the pan gesture again returns to its original position or the original position of the adjacent tab, scrolling within the tab preferably continues when necessary.

FIG. 6 illustrates another embodiment wherein interaction is supported in one or more vertically scrolling menus 602. Vertical pan interaction with ribbon galleries accepts vertically-oriented pan gestures and suspends any subsequent pan gestures horizontally until the interaction has been completed. In this example, an interaction input can be a vertical pan gesture within one of the scrolling menus 602. In response, the scrolling menu scrolls vertically to display more sub-menu items while horizontal panning is temporarily inhibited.

Receiving a “tap” interaction input, such as a user tapping a menu item, indicates to the system that the tapped menu choice has been selected. The system can distinguish based on the initial position and final position whether a tap gesture or a pan gesture is intended.

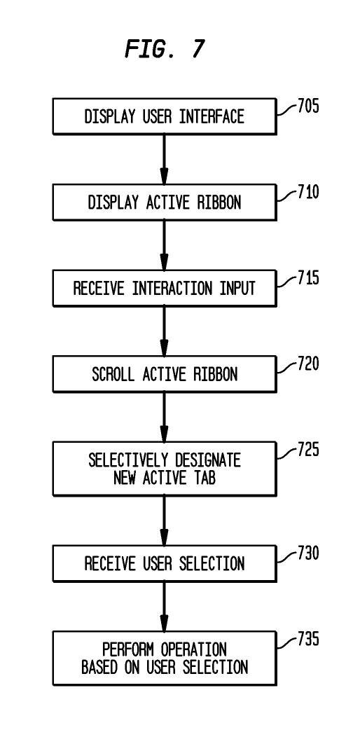

FIG. 7 illustrates a flowchart of a process in accordance with disclosed embodiments, that can be performed by a data processing system 100 or other system having a touch input device such as a touchscreen, touchpad, or otherwise, including data processing systems in the form of laptop computers, tablet computers, smartphones, or other consumer devices. Such data processing systems are referred to generically as the “system” below.

The system displays a user interface that includes a menu bar having a plurality of tabs (705). Each tab is associated with at least one sub-menu item, and the plurality of tabs includes an active tab and at least one non-active tab. This can include displaying the active tab with a different appearance than the non-active tab(s).

The system displays, in the menu bar, an active ribbon that includes the sub-menu items associated with the active tab (710).

The system receives, in the menu bar, an interaction input (715). The interaction input can be a pan gesture, a flick gesture, or otherwise. The interaction input can be received by a touch input device including a touch screen or touchpad, and can be a finger-touch input or a stylus input. “In the menu bar” refers to a touch input, such as on a touchscreen display, that is in the displayed area of the menu bar, or to a touch input, such as on a touchpad, in an area of the touchpad that corresponds to the displayed area of the menu bar. The touch input having an initial position and a final position, and the system can measure the velocity of the touch input between the initial position and the final position.

Based on the interaction input, the system scrolls the active ribbon to display additional sub-menu items (720). The additional submenu items can be additional sub-menu items associated with the active tab, and the scrolling can include simultaneously displaying sub-menu items associated with the active tab and at least one sub-menu item associated with a non-active tab. The additional sub-menu items can be sub-menu items associated with a next adjacent non-active tab. The scrolling can be based on the velocity of the touch input between the initial position and the final position. Scrolling the active ribbon to display additional sub-menu items can appear to a user as a continuous chain of sub-menu items in a ribbon area of the menu bar.

If the additional submenu items are sub-menu items associated with a next adjacent non-active tab, the system designates the next adjacent non-active tab as the active tab and designates the previous active tab as a non-active tab (725). This can include displaying the new active tab with a different appearance than the new non-active tab(s). This can be conditional on whether at least half of the additional sub-menu items are sub-menu items associated with the next adjacent non-active tab, whether a plurality of the additional sub-menu items are sub-menu items associated with the next adjacent non-active tab, or otherwise.

The system can receive a user selection of one of the sub-menu items (730).

The system can then perform an operation based on the user selection (735). Such an operation can include, but is not limited to, a CAD operation.

Of course, those of skill in the art will recognize that, unless specifically indicated or required by the sequence of operations, certain steps in the processes described above may be omitted, performed concurrently or sequentially, or performed in a different order.

Additional embodiments are completed, including but not limited to, those that provide coordination with other types of UI elements on the ribbon. For example, other elements located on the ribbon may also respond in a similar manner to pan or gesture-based interaction. When a pan gesture is identified as being for a given user interface element, panning for other elements may be blocked.

Additional embodiments are contemplated, including those where the user interacts with the menu system in various ways, including but not limited to pinching or other interaction.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. A method performed by a data processing system, comprising:
displaying a user interface that includes a menu bar having a plurality of tabs, wherein each tab is associated with at least one sub-menu item, and the plurality of tabs includes an active tab and at least one non-active tab;
displaying, in the menu bar, an active ribbon that includes the sub-menu items associated with the active tab;
receiving, in the menu bar, an interaction input;
scrolling the active ribbon to display additional sub-menu items based on the interaction input, including simultaneously displaying sub-menu items associated with the active tab and at least one sub-menu item associated with a non-active tab; and
designating a next adjacent non-active tab as the active tab, and designating the previous active tab as a non-active tab, when at least half of the additional sub-menu items are sub-menu items associated with the next adjacent non-active tab.

2. The method of claim 1, wherein the active tab is displayed with a different appearance than the non-active tab.

3. The method of claim 1, wherein the interaction input is one of a pan gesture and a flick gesture, and is received by a touch input.

4. The method of claim 1, wherein the additional sub-menu items are additional sub-menu items associated with the active tab.

5. The method of claim 1, wherein the interaction input is a touch input having an initial position and a final position, and the scrolling is based on the velocity of the touch input between the initial position and the final position.

6. The method of claim 1, wherein scrolling the active ribbon to display additional sub-menu items appears to a user as a continuous chain of sub-menu items in a ribbon area of the menu bar.

7. The method of claim 1, wherein the system also receives a user selection of one of the sub-menu items and performs an operation based on the user selection.

8. A data processing system comprising:
a processor;
an accessible memory;
a display; and
a touch input device, the data processing system particularly configured to
display a user interface, on the display, that includes a menu bar having a plurality of tabs, wherein each tab is associated with at least one sub-menu item, and the plurality of tabs includes an active tab and at least one non-active tab;
display, in the menu bar, an active ribbon that includes the sub-menu items associated with the active tab;
receive, in the menu bar, an interaction input via the touch input device;
scroll the active ribbon to display additional sub-menu items based on the interaction input, including simultaneously displaying sub-menu items associated with the active tab and at least one sub-menu item associated with a non-active tab; and
designate a next adjacent non-active tab as the active tab, and designating the previous active tab as a non-active tab, when at least half of the additional sub-menu items are sub-menu items associated with the next adjacent non-active tab.

9. The data processing system of claim 8, wherein the active tab is displayed with a different appearance than the non-active tab.

10. The data processing system of claim 8, wherein the interaction input is one of a pan gesture and a flick gesture, and is received by a touch input.

11. The data processing system of claim 8, wherein the additional sub-menu items are additional sub-menu items associated with the active tab.

12. The data processing system of claim 8, wherein the interaction input is a touch input having an initial position and a final position, and the scrolling is based on the velocity of the touch input between the initial position and the final position.

13. The data processing system of claim 8, wherein scrolling the active ribbon to display additional sub-menu items appears to a user as a continuous chain of sub-menu items in a ribbon area of the menu bar.

14. The data processing system of claim 8, wherein the system also receives a user selection of one of the sub-menu items and performs an operation based on the user selection.

15. A non-transitory computer-readable medium encoded with executable instructions that, when executed, cause one or more data processing systems to:
display a user interface, on a display, that includes a menu bar having a plurality of tabs, wherein each tab is associated with at least one sub-menu item, and the plurality of tabs includes an active tab and at least one non-active tab;
display, in the menu bar, an active ribbon that includes the sub-menu items associated with the active tab;
receive, in the menu bar, an interaction input via a touch input device;
scroll the active ribbon to display additional sub-menu items based on the interaction input, including simultaneously displaying sub-menu items associated with the active tab and at least one sub-menu item associated with a non-active tab; and
designate a next adjacent non-active tab as the active tab, and designating the previous active tab as a non-active tab, when at least half of the additional sub-menu items are sub-menu items associated with the next adjacent non-active tab.

16. The computer-readable medium of claim 15, wherein the active tab is displayed with a different appearance than the non-active tab.

17. The computer-readable medium of claim 15, wherein the interaction input is one of a pan gesture and a flick gesture, and is received by a touch input.

18. The computer-readable medium of claim 15, wherein the additional sub-menu items are additional sub-menu items associated with the active tab.

19. The computer-readable medium of claim 15, wherein the interaction input is a touch input having an initial position and a final position, and the scrolling is based on the velocity of the touch input between the initial position and the final position.

20. The computer-readable medium of claim 15, wherein scrolling the active ribbon to display additional sub-menu items appears to a user as a continuous chain of sub-menu items in a ribbon area of the menu bar.
